(19) United States
(12) Patent Application Publication
(10) Pub. No.: US 2025/0103361 A1
(43) Pub. Date: Mar. 27, 2025

(54) System and method for interacting with a physical device through a virtual twin of the device

(71) Applicant: Bank of America Corporation, Charlotte, NC (US)

(72) Inventors: Shailendra Singh, Maharashtra (IN); Durga Prasad Kutthumolu, Telangana (IN)

(21) Appl. No.: 18/473,736

(22) Filed: Sep. 25, 2023

(51) Int. Cl. G06F 9/455; G01S 17/89; G06T 17/00; G06V 10/25; G06V 10/44; G06V 10/74

(52) U.S. Cl. CPC G06F 9/455; G01S 17/89; G06T 17/00; G06V 10/25; G06V 10/44; G06V 10/761

(57) ABSTRACT

A system receives an image from a camera, where the image shows a physical device. The system, via deep learning object detection algorithm, determines the identity of the physical device. The system generates a virtual device in a virtual environment, where the virtual device is a virtual representation of the physical device. The system receives a user request that indicates the virtual device is requested to perform an operation. In response, the system establishes a communication path to the physical device and communicates a control signal to the physical device that causes the physical device to perform the operation.

### TECHNICAL FIELD

The present disclosure relates generally to information security, and more specifically to a system and method for interacting with a physical device through a virtual twin of the device.

### BACKGROUND

People interact with physical devices in the real world to instruct the physical device to perform certain operations. Users of virtual environments may use avatars to operate within the virtual environment.

### SUMMARY

The disclosed system described in the present disclosure is particularly integrated into a practical application of generating a virtual counterpart of a physical device and facilitating interaction with the physical device through the virtual counterpart device. Therefore, the disclosed system provides remote access and accessibility to physical devices via the counterpart virtual devices. This leads to implementing an unconventional user experience in a virtual environment to allow users to operate avatars to interact with physical devices through virtual devices in the virtual environment. For example, the disclosed system may be used for home automation, office automation, accessibility to individuals with disabilities, remote troubleshooting of physical devices, and the like. Therefore, the disclosed system provides technical improvements to virtual reality implementation technology.

In an example scenario, assume that a user wants to use a physical. In the current approaches, the user would have to interact with the physical device directly. However, the current approaches do not allow the user to interact with the physical device through its virtual twin device. The disclosed system is configured to implement the computing device that is configured to allow interaction with the physical device via its twin virtual device. Therefore, the disclosed system facilitates remote control and accessibility to various physical devices via their twin virtual devices.

The disclosed system is further configured to generate a virtual device that is a virtual representation of the physical device. For example, a computing device may detect the physical device based on images captured by a camera and other sensor data. In response to detecting the physical device, the computing device may implement a virtual reality computing framework to generate the virtual representation of the physical device in the virtual environment. For example, the computing device (e.g., via the virtual reality computing framework) may render a detailed three-dimensional virtual model of the physical device. In response, the user may access and interact with the virtual device in the virtual environment. For example, the user may access the virtual environment from a display screen of the computing device.

The disclosed system is further configured to pair the computing device with the physical device. For example, the computing device may be paired with the physical device via a wireless communication protocol. When the computing device is paired with the physical device, the physical device 130 may be onboarded onto the computing device. The onboarding process may include data synchronization between the physical device and the virtual device, for example, by sending a query message to the physical device to provide access to its memory and in response to the physical device granting access to its memory, accessing the memory of the physical device and synchronizing the data stored in the memory of the physical device with the virtual device. The onboarding process may further include functionality mapping between the physical device and the virtual device, for example, by identifying buttons, screens, and input methods to the physical device and linking them to corresponding virtual controls to the virtual device. The onboarding process may further include calibration and alignment which facilitates that the virtual device aligns precisely with the physical device and that user interactions with the virtual device correspond accurately to actions on the physical device. The onboarding process may further include testing and validation which may be initiated to ensure that the virtual device responds correctly to user inputs and accurately emulates the behavior of the physical device. The onboarding process may further include user guidance which includes providing users with instructions or guidance on how to interact with the virtual device using the interfaces of the computing device. The onboarding process may further include any other function that facilitates the virtual device to become a virtual counterpart of the physical device.

In response, the user may interact with the physical device via the virtual device. For example, the user may interact with the virtual device to perform an operation. In response, the physical device may detect the user request to the virtual device and communicate a control signal to the physical device to perform the requested operation. In response, the physical device may perform the requested operation.

In this manner, the disclosed system provides the practical applications of remote control and accessibility to physical devices via counterpart virtual devices, improved user experience in interacting with physical devices, and improved user experience in the virtual environment, among others. Accordingly, the disclosed system provides technical improvements to the virtual environment technology. For example, the disclosed system is configured to emulate the physical environment around the computing device into the virtual environment and enable interaction with the objects, such as the physical devices, in the physical environment via the counterpart virtual devices.

In some embodiments, a system comprises a memory, a camera, and a processor. The memory is configured to store a training dataset comprising a first image of a first physical device, wherein the first image is labeled with the first physical device. The camera is configured to capture images of objects within a field of view of the camera. The processor is associated with a virtual reality device and is operably coupled to the memory and camera. The processor is configured to receive a second image from the camera, wherein the second image shows a second physical device. The processor is further configured to extract a first set of features from the first image, wherein the first set of features indicates physical attributes of the first physical device. The processor is further configured to extract a second set of features from the second image, wherein the second set of features indicates physical attributes of the second physical device. The processor is further configured to compare each of the first set of features with a counterpart feature from among the second set of features. The processor is further configured to determine, based at least in part upon the comparison, that the first physical device corresponds to the second physical device. The processor is further configured to determine an identity of the second physical device in response to determining that the first physical device corresponds to the second physical device. The processor is further configured to generate a first virtual device in a virtual environment, wherein the first virtual device is a virtual representation of the second physical device. The processor is further configured to receive a user input that indicates the first virtual device is requested to perform a first operation. The processor is further configured to establish a communication path between the virtual reality device and the second physical device. In response to receiving the user input, the processor is further configured to communicate a first control signal to the second physical device, wherein the first control signal causes the second physical device to perform the first operation.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to interact with physical devices through their corresponding twin virtual devices;

FIG. 2 illustrates a block diagram of an embodiment of a computing device used by the system 100 of FIG. 1;

FIG. 3 illustrates an example operational flow of the system of FIG. 1 to interact with physical devices through their corresponding twin virtual devices; and

FIG. 4 illustrates an example flowchart of a method to interact with physical devices through their corresponding twin virtual devices.

### DETAILED DESCRIPTION

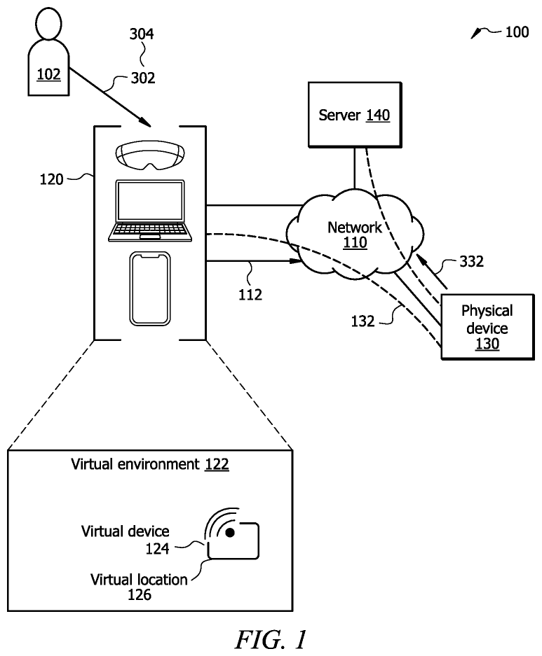

As described above, previous technologies fail to provide efficient and reliable solutions to interact with physical devices through their corresponding twin virtual devices. Embodiments of the present disclosure and its advantages may be understood by referring to FIGS. 1 through 4. FIGS. 1 through 4 are used to describe systems and methods to interact with physical devices through their corresponding twin virtual devices, according to some embodiments.

### System Overview

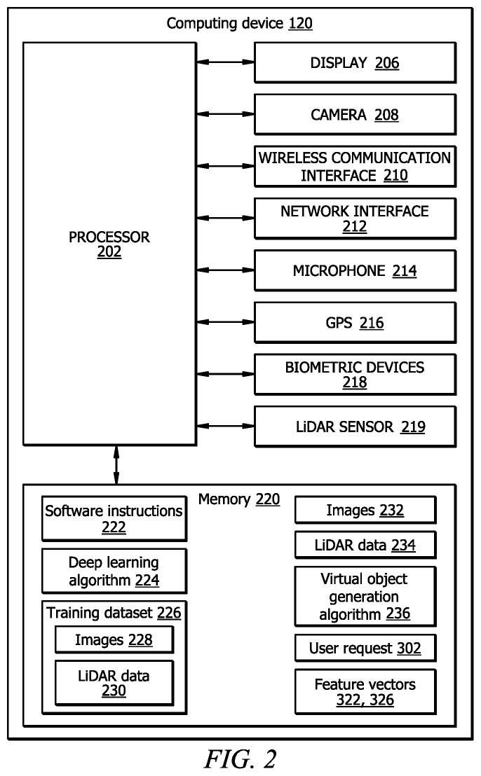

FIG. 1 illustrates an embodiment of a system 100 that is generally configured to interact with physical devices 130 through their corresponding twin virtual devices 124. For example, the system 100 is configured to communicate a control signal 112 to the physical device 130, where the control signal 112 may cause the physical device 130 to perform a requested operation. In some embodiments, the system 100 comprises the computing device 120 communicatively coupled to physical devices 130 and a server 140 via a network 110. Network 110 enables the communication among the components of the system 100. The computing device 120 is described in FIG. 2. The computing device 120 includes a processor 202 (see FIG. 2) in signal communication with a memory 220 (see FIG. 2). The memory 220 stores software instructions 222 (see FIG. 2) that when executed by the processor 202 cause the processor 202 to perform one or more operations of the computing device 120. In other embodiments, system 100 may not have all of the components listed and/or may have other elements instead of, or in addition to, those listed above. In general, the system 100 provides the capability to interact with physical devices 130 through their corresponding twin virtual devices 124. In an example scenario, assume that a user 102 wants to use a physical device 130. In the current approaches, the user 102 would have to interact with the physical device 130 directly. However, the current approaches do not allow the user 102 to interact with the physical device 130 through its virtual twin device 124. The system 100 is configured to implement the computing device 120 that is configured to facilitate interaction with the physical device 130 via its twin virtual device 124. Therefore, the system 100 facilitates remote control and accessibility to various physical devices 120 via their twin virtual devices 124. Thus, the system 100 provides the practical application of providing remote control and accessibility to various physical devices 120. For example, the system 100 may be used for home automation, office automation, accessibility to individuals with disabilities, remote troubleshooting of physical devices 120, and the like.

The system 100 is further configured to generate a virtual device 124 that is a virtual representation of the physical device 130. For example, the computing device 120 may detect the physical device 130 based on images captured by a camera and other sensor data. In response to detecting the physical device 130, the computing device 120 may implement a virtual reality computing framework to generate the virtual representation of the physical device 130 in the virtual environment 122. For example, the computing device 120 (e.g., via the virtual reality computing framework) may render a detailed three-dimensional virtual model of the physical device 130. In response, the user 102 may access and interact with the virtual device 124 in the virtual environment 122. For example, the user 102 may access the virtual environment 122 from a display screen of the computing device 120.

The system 100 is further configured to pair the computing device 120 with the physical device 130. For example, the computing device 120 may be paired with the physical device 130 via a wireless communication protocol. When the computing device 120 is paired with the physical device 130, the physical device 130 may be onboarded onto the computing device 120. In response, the user 102 may interact with the physical device 130 via the virtual device 124. For example, the user 102 may interact with the virtual device 124 to perform an operation 304. In response, the physical device 130 may detect the user request 302 to the virtual device 124 and communicate a control signal 112 to the physical device 130 to perform the requested operation 304. In response, the physical device 130 may perform the requested operation 304.

In this manner, the system 100 provides the practical applications of remote control and accessibility to physical devices 130 via counterpart virtual devices 124, improved user experience in interacting with physical devices 130, and improved user experience in the virtual environment 122, among others. Accordingly, the system 100 provides technical improvements to the virtual environment technology. For example, the system 100 is configured to emulate the physical environment around the computing device 120 into the virtual environment 122 and enable interacting with the objects, such as the physical devices 130, in the physical environment via the counterpart virtual devices 124.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may be configured to support any suitable type of communication protocol as would be appreciated by one of ordinary skill in the art.

### Computing Device

Computing device 120 is described in detail in the discussion of FIG. 2. In brief, a computing device 120 is generally any device that is configured to process data and interact with users 102. Examples of the computing device 120 include but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, keypad, or other appropriate terminal equipment usable by user 102. The computing device 120 may include a hardware processor, memory, and/or circuitry (see FIG. 2) configured to perform any of the functions or actions of the computing device 120 described herein. For example, a software application designed using software code may be stored in the memory and executed by the processor to perform the functions of the computing device 120. The computing device 120 is configured to communicate with other devices and components of the system 100 via the network 110. In the present disclosure, the computing device 120 may be interchangeably referred to as a user device or a spatial computing device.

FIG. 2 illustrates a block diagram of an embodiment of the computing device 120 used by the system 100 of FIG. 1. The computing device 120 may be configured to display the virtual environment 122 (see FIG. 1) within a field of view of the user (see FIG. 1), capture biometric, sensory, and/or physical information of the user wearing and/or operating the computing device 120, and to facilitate an electronic interaction between the user and other components of the system 100 (see FIG. 1), including the server 140.

In the illustrated embodiment, the computing device 120 comprises a processor 202, a memory 220, a display 206, a camera 208, a wireless communication interface 210, a network interface 212, a microphone 214, a global positioning system (GPS) sensor 216, biometric devices 218, and Light Detection and Ranging (LiDAR) sensors 219. The components of the computing device 120 are operably coupled to each other via wires and/or wireless communications. The processor 202 comprises one or more processors operably coupled to and in signal communication with memory 220, display 206, camera 208, wireless communication interface 210, network interface 212, microphone 214, GPS sensor 216, biometric devices 218, and LiDAR sensors 219. The one or more processors is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 202 may be a programmable logic device, a microcontroller, a microprocessor, or any suitable combination of the preceding. The one or more processors are configured to process data and may be implemented in hardware or software. For example, the processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions, including software instructions that when executed by the processor 202 cause the computing device 120 to perform one or more operations of the computing device 120 described herein. For example, the one or more processors are configured to execute instructions to implement the function disclosed herein, such as some or all of those described with respect to FIGS. 1-4. For example, processor 202 may be configured to display the virtual environment 122 (see FIG. 1), virtual objects and locations within the virtual environment 122 (see FIG. 1) on display 206, detect avatar location in the virtual environment, detect user location in the real world, identify virtual sub-environment/locations within the virtual environment, capture biometric information of a user via one or more of camera 208, microphone 214, biometric devices 218, and/or LiDAR sensors 219 and communicate via wireless communication interface 210 with other devices, such as the physical device 130 (see FIG. 1) and the server 140 (see FIG. 1).

LiDAR sensor 219 may be or include one or more LiDAR sensors that are configured to emit laser bursts and measure the time it takes for the emitted laser bursts to return after bouncing off objects in the surrounding environment. The LiDAR sensors 219 provide precise depth and distance measurements of objects within their field of view, which is surrounding the computing device 120 and/or surrounding the LiDAR sensor 219 itself. Each LiDAR sensor 219 may be any sensor configured to use lasers to sense objects in the environment in which the computing device 120 is located. LiDAR sensor 219 may operate by emitting laser bursts continuously, at predetermined intervals, or upon receiving a specific command from the user, allowing for real-time environmental mapping and object detection. The data captured by LiDAR sensor 219 is processed by the processor 202. The LiDAR sensor 219 provide LiDAR data 234 to the processor 202. The LiDAR data 234 may include point cloud data and may be used in applications, such as object recognition, augmented reality experiences, and spatial mapping. For example, the LiDAR sensor 219 may accurately detect and locate physical objects/devices 130 in the vicinity, enabling the computing device 120 to perform tasks, such as collision avoidance and creating detailed 3D maps of the environment. Additionally, LiDAR sensor 219 may be utilized for user identification purposes, where it captures a 3D representation of the user's surroundings, aiding in user authentication and verification through deep learning algorithms 224, ensuring secure and personalized interactions with the computing device 120.

Memory 220 may be non-transitory computer-readable medium. The memory 220 may be volatile or non-volatile and may comprise read-only memory (ROM), random-access memory (RAM), ternary content-addressable memory (TCAM), dynamic random-access memory (DRAM), and static random-access memory (SRAM). The memory 220 may include one or more of a local database, a cloud database, a network-attached storage (NAS), etc. The memory 220 comprises one or more disks, tape drives, or solid-state drives, and may be used as an over-flow data storage device, to store programs when such programs are selected for execution, and to store instructions and data that are read during program execution. The memory 220 may store any of the information described in FIGS. 1-4 along with any other data, instructions, logic, rules, or code operable to implement the function(s) described herein when executed by processor 202. For example, the memory 220 may store software instructions 222, training dataset 226, feature vectors 322, 326, user requests 302, deep learning algorithm 224, images 232, LiDAR data 234, virtual object generation algorithm 236, and/or any other data or instructions. The software instructions 222 may comprise any suitable set of instructions, logic, rules, or code operable to execute the processor 202 and perform the functions described herein, such as some or all of those described in FIGS. 1-4. In some embodiments, the memory 220 may store and/or include a browser or web application for a computing device 120 to interact with the virtual locations in the virtual environment 122 and other devices.

The deep learning algorithm 224 may be implemented by the processor 202 executing software instructions 222 and is generally configured to detect objects in the real physical world. In certain embodiments, the deep learning algorithm 224 may include a support vector machine, neural network, random forest, k-means clustering, Tree-based algorithm, Random Forest algorithm, etc. In certain embodiments, the deep learning algorithm 224 may be implemented by a plurality of neural network layers, convolutional neural network layers, Long-Short-Term-Memory (LSTM) layers, Bi-directional LSTM layers, recurrent neural network layers, and the like. In certain embodiments, the deep learning algorithm 224 may include a neural network image processing algorithm, neural network LiDAR data processing algorithm, object detection algorithm, and the like. The deep learning algorithm 224 may be configured to be implemented by unsupervised, semi-supervised, and/or supervised machine learning algorithms. For example, the deep learning algorithm 224 may be pre-trained to detect physical objects based on images 228 and/or LiDAR data 230 included in the training dataset 226. For example, the deep learning algorithm 224 may be given an image 228 of a device, where the image 228 is labeled with an identifier of the device. The deep learning algorithm 224 may extract a set of features from the image 228 and learn the associations between the image 228 and the extracted features. Similar operations may be performed for LiDAR data 230 associated with the device.

In the testing phase, the deep learning algorithm 224 may be given a testing image 232 of an object and asked to predict the identity of the object shown in the image 232. The deep learning algorithm 224 may extract a set of features from the image 232 and compare the extracted features with the features extracted from each image 228. The deep learning algorithm 224 may determine to which object shown in the images 228, the object shown in the image 232 corresponds based on the comparison. For example, if more than a threshold number of features extracted from an image 228 corresponds to the features extracted from the image 232, the deep learning algorithm 224 may determine that the object shown in the image 232 corresponds to or is the same object as the one shown in the image 228. Similar operations may be performed for LiDAR data 234 associated with the object.

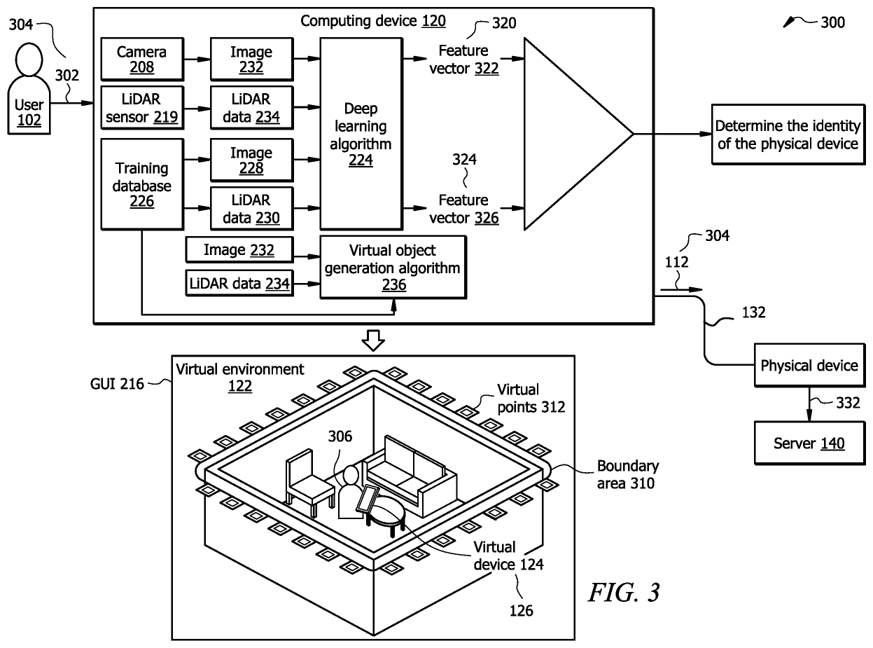

The virtual object detection algorithm 236 may be implemented by the processor 202 executing the software instructions 222 and is generally configured to generate virtual devices 124 based on input including images 232 of the counterpart physical devices 130, LiDAR data 234, training dataset 226, and other data. The virtual device generation algorithm 236 may use polygonal modeling to define the virtual shape and structure of the virtual device 124 to correspond to the physical shape and structure of the physical device 130 based on the images 232 and LiDAR data 234. In this manner, the virtual device generation algorithm 236 may generate a three-dimensional virtual representation of the physical device 130. The virtual object detection algorithm 236 may further add functionalities and attributes of the physical device 130 to the virtual device 124. For example, if the physical device 130 has a keyboard that receives input, the virtual object detection algorithm 236 may add a virtual keyboard that receives input to the virtual device 124. Essentially, the virtual object detection algorithm 236 may facilitate onboarding (e.g, integrating, emulating) the physical device 130 onto the computing device 120 and generating a virtual counterpart of the physical device 130 in the virtual environment 122 as the virtual device 124. Any interactions and functions of the physical device 130 may be mapped and attributed to the virtual device 124. Other examples are described in FIG. 3.

Display 206 may be or include a display screen that allows displaying objects (e.g., virtual and/or physical objects). Display 206 is configured to present visual information to a user (for example, user 102 in FIG. 1) in an augmented reality environment that overlays virtual or graphical objects onto tangible objects in a real scene in real time. In certain embodiments, the display 206 is configured to present visual information to the user as the virtual environment 122 (see FIG. 1) in real time. In certain embodiments, display 206 is a wearable optical display (e.g., glasses or a headset) configured to reflect projected images and enables a user to see through the display 206. For example, display 206 may comprise display units, lenses, and semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active-matrix OLED (AMOLED), an organic LED (OLED) display, a projector display, or any other suitable type of display as would be appreciated by one of ordinary skill in the art upon viewing this disclosure. In certain embodiments, display 206 is a graphical display on a computing device 120. For example, the graphical display may be the display of a tablet or smartphone configured to display an augmented reality environment with virtual or graphical objects overlaid onto tangible objects in a real scene in a real-time environment and/or virtual environment 122.

Camera 208 may be or include one or more cameras that are configured to capture images 232 of a field of view in front of the computing device 120 and/or in front of the camera 208. Examples of the camera 208 may include charge-coupled device (CCD) cameras and complementary metal-oxide semiconductor (CMOS) cameras. For example, camera 208 may be configured to capture images 232 of the physical device 130 that is in the field of view of the camera 208. Camera 208 may be configured to capture images continuously, at predetermined intervals, or on-demand. For example, camera 208 may be configured to receive a command from the user to capture an image 232. In another example, camera 208 is configured to continuously capture images to form a video stream. Camera 208 is communicably coupled to processor 202. In another example, the camera 208 may capture an image of a user 102 who is attempting to operate the computing device 120. The computing device 120 may use the image of the user 102 to perform facial recognition (included in the deep learning algorithm 224) to identify and verify the user 102. If the identity of the user 102 corresponds to the previously provided and authenticated user 102, the computing device 120 may allow the user 102 to operate the computing device 120.

Wireless communication interface 210 may be or include any communication interface that allows communication with other devices. The wireless communication interface 210 is configured to facilitate processor 202 in communicating with other devices. Wireless communication interface 210 is configured to employ any suitable communication protocol, including WIFI, and Bluetooth, among others.

Network interface 212 is configured to enable wired and/or wireless communications. The network interface 212 may be configured to communicate data between the computing device 120 and other devices, systems, or domains of the system 100 (see FIG. 1). For example, the network interface 212 may comprise a near field communication (NFC) interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 202 may be configured to send and receive data using the network interface 212. The network interface 212 may be configured to use any suitable type of communication protocol.

Microphone 214 may be or include a sound-detecting sensor circuit or sound-detecting sensor circuit array. Microphone 214 is generally configured to capture audio signals (e.g., voice signals or commands) from a user. Microphone 214 is communicably coupled to processor 202. Microphone 214 may communicate the detected audio signals to the processor 202.

GPS sensor 216 may be a location-detecting sensor circuit and configured to capture and provide geographical location information. For example, GPS sensor 216 is configured to provide a geographic location of a computing device 120. GPS sensor 216 may be configured to provide the geographic location information as a relative geographic location or an absolute geographic location. GPS sensor 216 may provide geographic location information using geographic coordinates (i.e., longitude and latitude) or any other suitable coordinate system. GPS sensor 216 is communicably coupled to processor 202. GPS sensor 216 may communicate the captured location of the computing device 120 to the processor 202.

Examples of biometric devices 218 may include but are not limited to, electrooculography sensors, retina scanners, fingerprint scanners, and the like. Biometric device 218 is communicably coupled to processor 202. Biometric devices 218 are configured to capture sensor data that includes information about a person's physical characteristics and to output a biometric signal based on captured information. The biometric device 218 may communicate the captured biometric features as sensor data to the processor 202.

Referring back to FIG. 1, the computing device 120 is configured to display a two-dimensional (2D) or three-dimensional (3D) representation of a virtual environment 122. Examples of a virtual environment 122 include, but are not limited to, a graphical or virtual representation of a metaverse, a map, a city, a building interior, a landscape, a fictional location, an alternate reality, or any other suitable type of location or environment.

### Physical Device

Physical device 130 may be any device that is configured to process data and interact with users. Examples of the physical devices 130 may include, but may not be limited to, a personal computer, a desktop computer, a workstation, a server, a laptop, a tablet computer, a mobile phone (such as a smartphone), smart glasses, VR glasses, a virtual reality device, an augmented reality device, an IoT device, or any other suitable type of device. The physical devices 130 may include a user interface, such as a display, a microphone, a camera, a keypad, or other appropriate terminal equipment usable by user 102. The physical devices 130 may include a hardware processor, memory, and/or circuitry (not explicitly shown) configured to perform any of the functions or actions of the physical devices 130 described herein. For example, a software application designed using software code may be stored in the memory and executed by the processor to perform the functions of the physical devices 130. The physical device 130 is configured to communicate with other devices and components of the system 100 via the network 110.

### Server

Server 140 generally includes a hardware computer system configured to manage activities within and with respect to the virtual environment 122. In certain embodiments, the server 140 may be implemented by a cluster of computing devices, such as virtual machines. For example, the server 140 may be implemented by a plurality of computing devices using distributed computing and/or cloud computing systems in a network. In certain embodiments, the server 140 may be configured to provide and/or receive services and resources (e.g., data and/or hardware resources) to and from the components of the system 100. For example, the server 140 may be configured to receive a control signal 112 to perform an operation 304, and in response, perform the operation 304.

Operational Flow for Interacting with a Physical Device Through the Virtual Counterpart

FIG. 3 illustrates an example operational flow 300 of the system 100 (see FIG. 1) for interacting with the physical device 130 through the virtual counterpart device 124. In operation, the operational flow 300 may begin when the user 102 wants to use the computing device 120 to interact with a physical device 130 through the virtual twin/counterpart device 124 in the virtual environment 122. In this process, the user 102 may attempt to operate the computing device 120 by, for example, entering their user credentials into a display screen of the computing device 120. The computing device 120 may verify that the user 102 is allowed to operate the computing device 120 if the received user credentials correspond to previously set user credentials. In another example, the computing device 120 may capture an image of the user 102 by the camera 208 and identify the user 102 by implementing a facial recognition algorithm. The computing device 120 may verify that the user 102 is allowed to operate the computing device 120 if the captured image of the user 102 corresponds to a previously provided image of the user 102.

When the user 102 is verified, the user 102 may operate the computing device 120. For example, the user 102 may access and view the virtual environment 122 on the display screen of the computing device 120. In response, the user 102 may operate the avatar 306 within the virtual environment 122. For example, the user 102 may operate the avatar 306 to interact with virtual objects inside the virtual environment 122. In some embodiments, the avatar 306 may resemble the user 102. In some embodiments, the user 102 may see virtual hands on the display screen of the computing device 120 being integrated into the virtual environment 122 and use the virtual hands to interact with the virtual objects.

For example, assume that the user 102 wants to interact with the physical device 130 that is within a boundary area 310 of the computing device 120. The boundary area 310 may be set by the user 102 and/or the computing device 120. For example, the user 102 may indicate or provide virtual anchor points or virtual markers 312 by pointing or gesturing, via the avatar 306 or virtual hands, to the virtual locations of the virtual markers 312 in the virtual environment 122. The computing device 120 may receive the virtual locations of the virtual markers 312 and generate the boundary area 310. The boundary area 310 may represent a geofence for setting rules for interacting with physical devices 130 via the counterpart virtual devices 124. For example, the rules may include a rule for sending control signals 112 to physical devices 130 when they enter the boundary area 310, where the control signals 112 may indicate to perform certain operations 304 set by users 102. In another example, the rules may include a rule for sending control signals 112 to physical devices 130 when they exit the boundary area 310, where the control signals 112 may indicate to stop performing the operations 304.

To determine whether the physical device 130 is within the boundary area 310, the computing device 120 may perform the following operations. The computing device 120 may receive an image 232 of the physical device 120 from the camera 208. For example, the computing device 120 may receive the image 232 of the physical device 120 when the physical device 120 is within the field of view of the camera 208. The computing device 120 may feed the image 232 of the physical device 120 to the deep learning algorithm 224 to determine the identity of the physical device 120.

The deep learning algorithm 224 may extract a set of features 320 from the image 232. The extracted features 320 may indicate physical attributes of the physical device 120. For example, the extracted features 320 may indicate the shape, size, colors, edges, and visual characteristics of the physical device 120. The computing device 120 may perform similar operations with respect to LiDAR data 234. For example, the computing device 120 may receive LiDAR data 234 from the LiDAR sensor 219 when the physical device 130 is within the detection range of the LiDAR sensor 219. The computing device 120 may feed the LiDAR data 234 to the deep learning algorithm 224 and extract features 320 from the LiDAR data 234. The features 320 may indicate the distance between the physical device 130 and the computing device 120, shape, size, colors, edges, and visual characteristics of the physical device 120. The features 320 may be represented by the feature vector 322 which comprises a set of numerical values. The LiDAR data 234 may include point cloud data that correspond to the surface of the physical device 130.

The computing device 120 may perform similar operations with respect to the images 228 and LiDAR data 230. For example, the computing device 120 may access the training dataset 226, feed the images 228 and LiDAR data 230 to the deep learning algorithm 224, and extract features 324 from each image 228 and each LiDAR data 230. In the case of an image 228 from the training dataset 226, the features 324 extracted from the image 228 may include the shape, size, colors, edges, and visual characteristics of a device shown in the image 228. In the case of a LiDAR data 230 from the training dataset 226, the features 324 extracted from the LiDAR data 230 may include the distance between the object (e.g., physical device 130) shown in the LiDAR data 230 and the LiDAR sensor 219 of the computing device 120, shape, size, colors, edges, and visual characteristics of the object shown in the LiDAR data 230. The features 324 may indicate the physical attributes of the device shown in the image 228 (e.g., physical device 130). The features 324 may be represented by the feature vector 326 which comprises a set of numerical values. The LiDAR data 230 may include point cloud data that correspond to the surface of the device shown in the LiDAR data 230. The computing device 120 may use the LiDAR data 234 to determine the distance between the computing device 120 and the physical device 130.

### Determining the Identity of the Physical Device

The computing device 120 may compare the feature vector 322 with the feature vector 326 to determine the similarity between the physical device 130 shown in the image 232 and the device shown in the image 228. In this process, the computing device 120 may compare each of the features 320 with the counterpart feature 324. For example, the computing device 120 may compare the size, color, and dimension of the physical device 120 shown in the image 232 with the size, color, and dimension of the device shown in the image 228, respectively. In some embodiments, comparing each feature 320 with the counterpart feature 324 may include comparing each of the numbers in the feature vector 322 with the counterpart number in the feature vector 326.

In comparing the feature vector 322 with the feature vector 326, in some embodiments, the computing device 120 may determine an Euclidean distance between the feature vector 322 and the feature vector 326. If the Euclidean distance between the feature vector 322 and the feature vector 326 is less than a threshold distance (e.g., less than 0.1 centimeters (cm), 0.2, etc.), the computing device 120 may determine that the physical device 130 shown in the image 232 corresponds to the device shown in the image 228. In other embodiments, the computing device 120 may use any method to determine the similarity between the images 232 and 228, such as cosine similarity, and the like. In response, the computing device 120 may determine the identity of the physical device 130 and identify the operations that the physical device 130 is configured to perform, among other information about the physical device 130.

### Generating a Virtual Counterpart of the Physical Device

The computing device 120 may implement the virtual object detection algorithm 236 to generate the virtual environment 122 and the virtual objects within the virtual environment 122. In generating the virtual device 124, the computing device 120 may feed multiple images 232 of the physical device 130, three-dimensional point cloud data in the LiDAR data 234 that indicates the details on the surface of the physical device 130, and other information about the physical device 130 to the virtual object generation algorithm 236, similar to that described in FIG. 1.

In some embodiments, the computing device 120 (e.g., virtual device generation algorithm 236) may tether the virtual location 126 of the virtual device 124 in the virtual environment 122 to the physical location of the physical device 130 in the global plane or real world. To this end, the computing device 120 may determine a pixel location coordinate of the physical device 130 in the image 232. In some embodiments, the computing device 120 may apply a homography matrix on the pixel location coordinate of the physical device 130 to determine the physical location coordinate of the physical device 130 in the global plane. The homography matrix comprises coefficients that are configured to translate between pixel locations in an image 232 or depth image 232 and physical location coordinates in a global plane. The computing device 120 uses the homography matrix to correlate between a pixel location in a particular image 232 with a physical location in the environment around the computing device 120.

For example, the physical location coordinate of the physical device 130 may be determined by multiplying the homography matrix with a matrix that includes the pixel location coordinates of the physical device 130 on the image 232. In another example, the pixel location coordinate of the physical device 130 on the image 232 may be determined by multiplying the inverse of the homography matrix with a matrix that includes the physical location coordinate of the physical device 130 in the global plane.

The computing device 120 may display the virtual device 124 within the virtual environment 122 on the GUI display 206. The computing device 120 may use the physical location coordinate of the physical device 130 to determine the virtual location 126 of the virtual device 124 such that the virtual location 126 of the virtual device 124 is tethered to the physical location of the physical device 130 in the real world. For example, the virtual device 124 may move in the virtual environment 122 similar to that the physical device 130 moved in the real world.

Interacting with the Physical Device Through the Virtual Counterpart Device

The computing device 120 may receive a request 302 from the user 102, where the request 302 indicates that the user 102 wants to interact with the virtual device 124 to perform an operation 304. For example, while the user 102 is operating with computing device 120, the user 102 may use a virtual hand or avatar 306 to interact with the virtual device 124 to perform the operation 304. In response to receiving the user request 302, the computing device 120 may establish a communication path 330 with the physical device 130. For example, the communication path 330 may be established by wireless communication protocols, such as WiFi, Bluetooth, and/or the like.

In some embodiments, establishing the communication path 132 between the computing device 120 and the physical device 130 may be in response to detecting that the physical device 130 has entered the boundary area 310. In this process, the physical device 130 is onboarded onto the computing device 120, for example, by implementing the virtual object generation algorithm 236. The process of onboarding the physical device 130 may include an authentication procedure to verify users attempting to interact with the physical device 130 via the computing device 120. The onboarding process may further include data synchronization between the physical device 130 and the virtual device 124, for example, by sending a query message to the physical device 130 to provide access to its memory and in response to the physical device 120 granting access to its memory, accessing the memory of the physical device 130 and synchronizing the data stored in the memory of the physical device 130 with a portion of the memory 220 that stores information associated with the virtual device 124. The onboarding process may further include functionality mapping between the physical device 130 and the virtual device 124, for example, by identifying buttons, screens, and input methods to the physical device 130 and linking them to corresponding virtual controls to the virtual device124. The onboarding process may further include calibration and alignment which facilitates that the virtual device 124 aligns precisely with the physical device 130 and that user interactions with the virtual device 124 correspond accurately to actions on the physical device 130. The onboarding process may further include testing and validation which may be initiated to ensure that the virtual device124 responds correctly to user inputs and accurately emulates the behavior of the physical device 130. The onboarding process may further include user guidance which includes providing users with instructions or guidance on how to interact with the virtual device 124 using the interfaces of the computing device 120. The onboarding process may further include any other function that facilitates the virtual device 124 to become a virtual counterpart of the physical device 130.

In response to receiving the user request 302 and establishing the communication path 132 with the physical device 130, the computing device 120 may communicate the control signal 112 to the physical device 130, where the control signal 112 causes the physical device 130 to perform the operation 304. For example, the control signal 112 may include software code or instructions to instruct the processor of the physical device 130 to perform the operation 304. In some embodiments, the operation 304 may include any operation that the physical device 130 is configured to perform, including communicating a data signal 332 to the server 140. Since the onboarding process is completed, the control signal 112 may be compatible with and executable by the physical device 130.

In some embodiments, the computing device 120 may detect the physical device 130 when the physical device 130 enters the boundary area 310. For example, the computing device 120 may determine a set of pixel location coordinates of the virtual markers 312 that correspond to the boundary area 310 around the computing device 120. The computing device 120 may receive an image 232 of a physical device 130 from the camera 208. The computing device 120 may determine a pixel location coordinate of the physical device 130 on the image 232. The computing device 120 may determine a physical location coordinate of the physical device 130 in the global plane by applying a homography on the determined pixel location of the physical device 130 on the image 232. Based on the determined physical location of the physical device 130, the computing device 120 may determine whether the physical device 130 has entered the boundary area 310. If it is determined that the physical device 130 has entered boundary area 310, the computing device 120 may generate the virtual device 124 which is a virtual representation of the physical device 130 in the virtual environment 122. In some embodiments, the computing device 120 may be configured to facilitate the coordination of operations among two or more physical devices 130 through user interactions with counterpart virtual devices 124 in the virtual environment 122.

Method for Interacting with a Physical Device Through the Virtual Counterpart

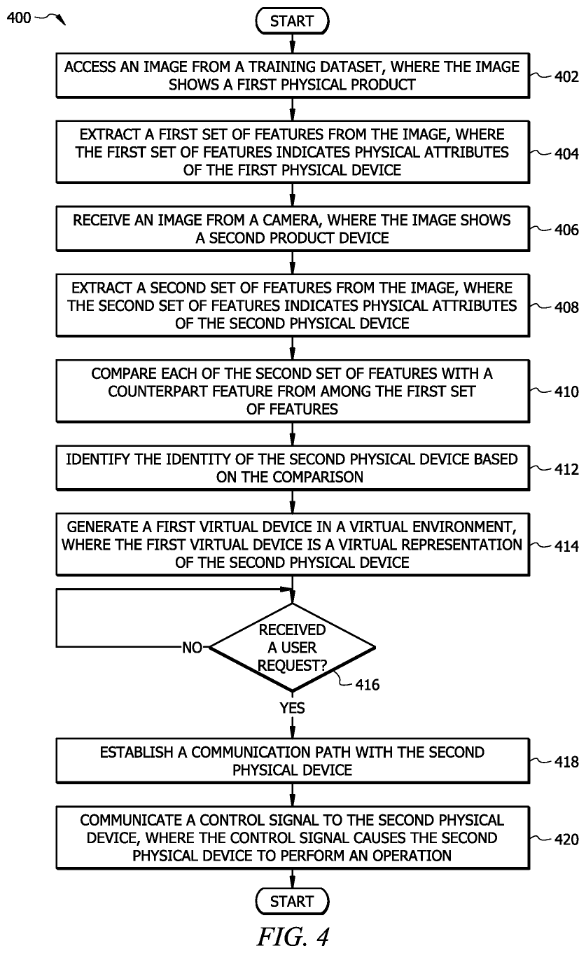

FIG. 4 illustrates an example flowchart of a method 400 for interacting with a physical device 130 through the virtual counterpart device 124 according to some embodiments. Modifications, additions, or omissions may be made to method 400. Method 400 may include more, fewer, or other operations. For example, operations may be performed in parallel or in any suitable order. While at times it is discussed that the system 100, computing device 120, server 140, physical device 130, or components of any of thereof perform some operations, any suitable system or components of the system may perform one or more operations of the method 400. For example, one or more operations of method 400 may be implemented, at least in part, in the form of software instructions 222 of FIG. 1, stored on a tangible non-transitory machine-readable medium (e.g., memory 220 of FIG. 1) that when run by one or more processors (e.g., processor 202 of FIG. 1) may cause the one or more processors to perform operations 402-418.

At operation 402, the computing device 120 accesses an image 228 from a training dataset 226, where the image 228 shows a first physical device. The computing device 120 may access other images 228, where other images 228 show a different physical product.

At operation 404, the computing device 120 extracts a first set of features 324 from the image 228, where the first set of features 324 indicates the physical attributes of the first physical product. For example, the computing device 120 feeds the image 228 to the deep learning algorithm 224 to extract the features 324 from the image 228, similar to that described in FIG. 3.

At operation 406, the computing device 120 receives an image 232 from the camera 208, where the image 232 shows a second physical device 130. At operation 408, the computing device 120 extracts a second set of features 320 from the image 232, where the second set of features 320 indicates physical attributes of the second physical device 130. For example, the computing device 120 feeds the image 232 to the deep learning algorithm 224 to extract the features 320 from the image 232, similar to that described in FIG. 3.

At operation 410, the computing device 120 compares each of the second set of features 320 with a counterpart feature 324 from among the first set of features 324. In this process, the computing device 120, via the deep learning algorithm 224, may compare the feature vector 322 with the feature vector 326, similar to that described in FIG. 3.

At operation 412, the computing device 120 identifies the identity of the second physical device 130 based on the comparison. For example, if the computing device 120 determines that the physical device shown in the image 228 corresponds to the physical device 130 shown in the image 232, the computing device 120 may determine that the physical device 130 is the same device shown in the image 228.

At operation 414, the computing device 120 generates a virtual device 124 in the virtual environment 122, where the virtual device 124 is a virtual representation of the second physical device 130. For example, the computing device 120 may implement the virtual object generation algorithm 236 to generate the virtual device 124, similar to that described in FIG. 3.

At operation 416, the computing device 120 determines whether a user request 302 is received. For example, the user request 302 may indicate that the virtual device 124 is requested by the user 102 to perform the operation 304. If it is determined that that the user request 302 is received, method 400 proceeds to operation 418. Otherwise, the method 400 remains at operation 416.

At operation 418, the computing device 120 establishes a communication path 132 with the second physical device 130, similar to that described in FIG. 3.

At operation 420, the computing device 120 communicates a control signal 112 to the second physical device 130, where the control signal causes the physical device 130 to perform the operation 304. In some embodiments, the method 400 may include processing and using LiDAR data 234, 230 to determine the identity of the physical device 130, generate the virtual device 124, and other operations, similar to that described in FIG. 3.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system comprising:
a memory configured to store a training dataset comprising a first image of a first physical device, wherein the first image is labeled with the first physical device;
a camera configured to capture images of objects within a field of view of the camera; and
a processor associated with a spatial computing device, operably coupled to the memory and camera, and configured to:
receive a second image from the camera, wherein the second image shows a second physical device;
extract a first set of features from the first image, wherein the first set of features indicates physical attributes of the first physical device;
extract a second set of features from the second image, wherein the second set of features indicates physical attributes of the second physical device;
compare each of the first set of features with a counterpart feature from among the second set of features;
determine, based at least in part upon the comparison, that the first physical device corresponds to the second physical device;
determine an identity of the second physical device in response to determining that the first physical device corresponds to the second physical device;
generate a first virtual device in a virtual environment, wherein the first virtual device is a virtual representation of the second physical device;
receive a user input that indicates the first virtual device is requested to perform a first operation;
establish a communication path between the spatial computing device and the second physical device; and
in response to receiving the user input, communicate a first control signal to the second physical device, wherein the first control signal causes the second physical device to perform the first operation.

2. The system of claim 1, wherein the processor is further configured to:
determine a first pixel location coordinate associated with the second physical device in the first image;
determine a first physical location coordinate of the second physical device in a global plane based at least in part upon the first pixel location coordinate associated with the second physical device; and
display the first virtual device on a graphical user interface such that a location of the first virtual device in the graphical user interface is tethered to a location of the second physical device in the global plane.

3. The system of claim 1, wherein the processor is further configured to:
determine a set of pixel location coordinates corresponding to a boundary area around the spatial computing device;
receive a second image from the camera, wherein the second image shows a third physical device;
determine a second pixel location coordinate associated with the third physical device in the second image;
determine a second physical location coordinate of the third physical device in a global plane based at least in part upon the second pixel location coordinate associated with the third physical device;
detect that the third physical device has entered the boundary area based at least in part upon the second physical location coordinate; and
in response to detecting that the third physical device has entered the boundary area, generate a second virtual device in the virtual environment, wherein the second virtual device is a virtual representation of the third physical device.

4. The system of claim 3, wherein establishing the communication path between the spatial computing device and the second physical device is in response to detecting that the second physical device has entered the boundary area.

5. The system of claim 1, wherein:
the first set of features is represented by a first feature vector comprising a first set of numerical values;
the second set of features is represented by a second feature vector comprising a second set of numerical values; and
comparing each of the first set of features with the counterpart feature from among the second set of features comprises comparing each of the first set of numerical values with a counterpart number from among the second set of numerical values.

6. The system of claim 1, wherein the processor is further configured to:
receive Light Detection and Ranging (LiDAR) data from a LiDAR sensor circuit, wherein the LiDAR data indicates a distance of the second physical device to the spatial computing device; and
determine the distance between the second physical device to the spatial computing device based at least in part upon the LiDAR data.

7. The system of claim 1, wherein the first operation comprises communicating a particular signal to a server.

8. A method comprising:
storing a training dataset comprising a first image of a first physical device, wherein the first image is labeled with the first physical device;
capturing images of objects within a field of view of a camera;
receiving a second image from the camera, wherein the second image shows a second physical device;
extracting a first set of features from the first image, wherein the first set of features indicates physical attributes of the first physical device;
extracting a second set of features from the second image, wherein the second set of features indicates physical attributes of the second physical device;
comparing each of the first set of features with a counterpart feature from among the second set of features;
determining, based at least in part upon the comparison, that the first physical device corresponds to the second physical device;
determining an identity of the second physical device in response to determining that the first physical device corresponds to the second physical device;
generating a first virtual device in a virtual environment, wherein the first virtual device is a virtual representation of the second physical device;
receiving a user input that indicates the first virtual device is requested to perform a first operation;
establishing a communication path between a spatial computing device and the second physical device; and
in response to receiving the user input, communicating a first control signal to the second physical device, wherein the first control signal causes the second physical device to perform the first operation.

9. The method of claim 8, further comprising:
determining a first pixel location coordinate associated with the second physical device in the first image;
determining a first physical location coordinate of the second physical device in a global plane based at least in part upon the first pixel location coordinate associated with the second physical device; and
displaying the first virtual device on a graphical user interface such that a location of the first virtual device in the graphical user interface is tethered to a location of the second physical device in the global plane.

10. The method of claim 8, further comprising:
determining a set of pixel location coordinates corresponding to a boundary area around the spatial computing device;
receiving a second image from the camera, wherein the second image shows a third physical device;
determining a second pixel location coordinate associated with the third physical device in the second image;
determining a second physical location coordinate of the third physical device in a global plane based at least in part upon the second pixel location coordinate associated with the third physical device;
detecting that the third physical device has entered the boundary area based at least in part upon the second physical location coordinate; and
in response to detecting that the third physical device has entered the boundary area, generating a second virtual device in the virtual environment, wherein the second virtual device is a virtual representation of the third physical device.

11. The method of claim 10, wherein establishing the communication path between the spatial computing device and the second physical device is in response to detecting that the second physical device has entered the boundary area.

12. The method of claim 8, wherein:
the first set of features is represented by a first feature vector comprising a first set of numerical values;
the second set of features is represented by a second feature vector comprising a second set of numerical values; and
comparing each of the first set of features with the counterpart feature from among the second set of features comprises comparing each of the first set of numerical values with a counterpart number from among the second set of numerical values.

13. The method of claim 8, further comprising:
receiving Light Detection and Ranging (LiDAR) data from a LiDAR sensor circuit, wherein the LiDAR data indicates a distance of the second physical device to the spatial computing device; and
determining the distance between the second physical device to the spatial computing device based at least in part upon the LiDAR data.

14. The method of claim 8, wherein the first operation comprises communicating a particular signal to a server.

15. A non-transitory computer-readable medium storing instructions that when executed by a processor, cause the processor to:
store a training dataset comprising a first image of a first physical device, wherein the first image is labeled with the first physical device;
capture images of objects within a field of view of a camera;
receive a second image from the camera, wherein the second image shows a second physical device;
extract a first set of features from the first image, wherein the first set of features indicates physical attributes of the first physical device;
extract a second set of features from the second image, wherein the second set of features indicates physical attributes of the second physical device;
compare each of the first set of features with a counterpart feature from among the second set of features;
determine, based at least in part upon the comparison, that the first physical device corresponds to the second physical device;
determine an identity of the second physical device in response to determining that the first physical device corresponds to the second physical device;
generate a first virtual device in a virtual environment, wherein the first virtual device is a virtual representation of the second physical device;
receive a user input that indicates the first virtual device is requested to perform a first operation;
establish a communication path between a spatial computing device and the second physical device; and
in response to receiving the user input, communicate a first control signal to the second physical device, wherein the first control signal causes the second physical device to perform the first operation.

16. The non-transitory computer-readable medium of claim 15, wherein the instructions further cause the processor to:
determine a first pixel location coordinate associated with the second physical device in the first image;
determine a first physical location coordinate of the second physical device in a global plane based at least in part upon the first pixel location coordinate associated with the second physical device; and
display the first virtual device on a graphical user interface such that a location of the first virtual device in the graphical user interface is tethered to a location of the second physical device in the global plane.

17. The non-transitory computer-readable medium of claim 15, wherein the instructions further cause the processor to:
determine a set of pixel location coordinates corresponding to a boundary area around the spatial computing device;
receive a second image from the camera, wherein the second image shows a third physical device;
determine a second pixel location coordinate associated with the third physical device in the second image;
determine a second physical location coordinate of the third physical device in a global plane based at least in part upon the second pixel location coordinate associated with the third physical device;
detect that the third physical device has entered the boundary area based at least in part upon the second physical location coordinate; and
in response to detecting that the third physical device has entered the boundary area, generate a second virtual device in the virtual environment, wherein the second virtual device is a virtual representation of the third physical device.

18. The non-transitory computer-readable medium of claim 17, wherein establishing the communication path between the spatial computing device and the second physical device is in response to detecting that the second physical device has entered the boundary area.

19. The non-transitory computer-readable medium of claim 15, wherein:
the first set of features is represented by a first feature vector comprising a first set of numerical values;
the second set of features is represented by a second feature vector comprising a second set of numerical values; and
comparing each of the first set of features with the counterpart feature from among the second set of features comprises comparing each of the first set of numerical values with a counterpart number from among the second set of numerical values.

20. The non-transitory computer-readable medium of claim 15, wherein the instructions further cause the processor to:
receive Light Detection and Ranging (LiDAR) data from a LiDAR sensor circuit, wherein the LiDAR data indicates a distance of the second physical device to the spatial computing device; and
determine the distance between the second physical device to the spatial computing device based at least in part upon the LiDAR data.
